(19) United States
(12) Patent Application Publication
(10) Pub. No.: US 2016/0194587 A1
(43) Pub. Date: Jul. 7, 2016

(54) BREWING, FERMENTING, AND SERVICE KETTLE KEG WITH COMPRESSION DISPLACEMENT PLATE

(71) Applicant: Brian Ellegood, Winlock, WA (US)

(72) Inventor: Brian Ellegood, Winlock, WA (US)

(21) Appl. No.: 14/588,783

(22) Filed: Jan. 2, 2015

(51) Int. Cl. C12C 11/00; B67D 1/00; B67D 1/08; C12C 13/10

(52) U.S. Cl. CPC C12C 11/006; C12C 13/10; B67D 1/0004; B67D 1/0801; B67D 2001/0098; B67D 2001/0824

(57) ABSTRACT

A kettle keg for brewing and dispensing beer comprises a container having a bottom and upright sidewalls defining a chamber configured to receive a fermenting liquid. A compression displacement plate is slidably received within the container and between the upright sidewalls and configured to rest on a top surface of liquid received in the container to define an adjustable volume of the chamber. A dispensing port is in fluid communication with the chamber. Means for forcing the compression displacement plate against the top surface of the liquid create a motive force of the liquid toward the dispensing port.

### BACKGROUND OF THE INVENTION

This invention relates generally to beer brewing equipment and more particularly to smaller volume fermentation tanks for personal brewing and dispensing of fermented liquid.

Home brewing of fermented beverages such as beer has gained in popularity. Kits are available that include a 5-gallon glass carboy fitted with a rubber stopper to prevent bacteria and oxygen from entering during the fermentation process. After the brewing process is complete, the beer is hand-pumped into bottles for storage and serving or alternately stored in a keg for dispensing.

From the middle ages, when the use of hops made beer clear, until the 1890's, beer was stored in and dispensed from wooden barrels through simple valves and delivered to the drinker mug or glass by gravity flow. From the 1950's to the present most draft beer has been shipped in and dispensed from kegs that are cylindrical, made of stainless steel or aluminum and contain an extractor tube.

To dispense the beer from the keg a pressurizing gas, air or CO₂, is forced into the keg through a beer keg tap. The liquid beer is forced out through the extractor tube, flexible hoses and a delivery faucet. Air is very undesirable as a pressurizing gas because the oxygen in air makes beer quickly go stale or sour. Air can be used when the entire keg is to be drunk quickly. But ambient air cannot be used as a pressurizing gas if the keg must be stored and the beer consumed over a period of time.

Conventional modern-day beer dispensing systems typically use compressed gas as a dispensing agent. A first such system is a commercial system that uses heavy pressure bottles of compressed carbon dioxide gas operating through regulators and pressure lines to pressurize one or more kegs. The other is a consumer system usually used at a party or picnic that uses an air pump, which may be a hand powered or electrically operated compressor, to pressurize the keg. This is therefore commonly known as a picnic pump system.

Advantages of the commercial beer dispensing systems include the use of CO₂ dispensing systems that prevent air from coming in contact with the keg beer and thus allowing the keg beer to stay fresh for a longer period of time than when air is used as a pressurizing gas. Another advantage of a commercial beer dispensing system is the ability to control the pressure of the gas supplied to the keg through the use of adjustable regulators and pressure gauges. This feature is a marked advantage over a picnic pump system as it allows the pressure to be finely tuned to the individual type of beer or the specific temperature of the keg to prevent excessive foaming of the dispensed beer as is often encountered in the picnic pump systems.

Examples of commercial beer dispensing systems may be found in most bars and restaurants. This equipment is cumbersome and industrial. Their ‘rat's nest’ of tubing is a common feature behind bars. These commercial CO₂ dispensing systems weigh hundreds of pounds and can operate dozens of beer keg taps and draft beer dispensers. This equipment is completely unsuitable for use at picnics, parties or for the large and growing number of drinkers who wish to keep a keg of beer at home in their refrigerator so they can have draft beer at home on demand.

Picnic pumps such as the one taught by U.S. Pat. No. 4,711,377, issued to Brown on Dec. 8, 1987 use a hand-operated air pump. Such pumps are common and exist in hundreds of variations. These pumps are small and lightweight, but they pressurize the beer keg with air, which makes them unsuitable for use with a home keg because contact with the oxygen in air quickly ruins the beer.

Approaches to improving this picnic pump include U.S. Pat. No. 5,785,211 (using an electrically powered compressor), U.S. Pat. No. 5,199,609 and U.S. Pat. No. 2,571,433 (using a small CO₂ bottle to pressurize a specialized beer tank), and refrigerated one keg systems, such as the Beer Baron® sold by Ajex USA, Inc.

Each of these prior art methods has recognized disadvantages and require a charged CO₂ canister and/or other specialized equipment to properly operate the keg and dispense the beer. Furthermore, each of these prior art systems are single purpose devices used solely for dispensing beer that has already been brewed. Accordingly, the need remains for alternate methods for including a brewing, storage, and dispensing system in a single device.

### SUMMARY OF THE INVENTION

A kettle keg for brewing and dispensing beer comprises a container having a bottom and upright sidewalls defining a chamber configured to receive a fermenting liquid. A compression displacement plate is slidably received within the container and between the upright sidewalls and configured to rest on a top surface of liquid received in the container to define an adjustable volume of the chamber. A dispensing port is in fluid communication with the chamber. Means for forcing the compression displacement plate against the top surface of the liquid create a motive force of the liquid toward the dispensing port.

The method for dispensing beer according to aspects of the invention comprise fermenting beer within a chamber bounded by a bottom, upright sidewalls, and a compression displacement plate moveable between the upright sidewalls to create an adjustable volume within the chamber. The compression displacement plate is allowed to move vertically between the upright sidewalls while contacting the top surface of the fermenting beer to accommodate a change in volume of the fermenting beer until the beer is substantially fermented and ready for drinking. The compression displacement plate is then forced against a top surface of the fermenting beer to create a force on the beer toward a dispensing port. To dispense the beer, a dispensing port is opened to allow the substantially fermented beer to flow therethrough under continuing force of the compression displacement plate whereby the compression displacement plate is allowed to slide downward as the beer is dispensed.

One iteration of the Newton Kettle/Keg (NKK) may include an appurtenance which completely contains hops, grains, or any other product which is to interact with the fluid to alter the taste of a beverage while disallowing the mixture to escape containment. This appurtenance made be constructed of a mesh screen or other perforated material such that the mesh or perforations are smaller than the size of the material contained therein yet still allow the circulation of water or other fluid in and around the contents in order to impart flavor or other function.

One iteration of the NKK may include a compression displacement plate with a connection coil attached internally allowing for bi-directional flow allowing the beer or beverage or other liquid to flow through the coil out of the NKK as the displacement plate is lowered, as well as allowing beer to flow through the coil into the NKK allowing for a beer to be mixed with a beer, or a beer to be mixed with a beverage, or a beer to be mixed with another liquid, or a liquid to be mixed with another liquid, or a liquid to be mixed with a beverage, or a beverage to be mixed with a beverage, or to allow water of varying temperature to enter and exit out of an outtake valve at the bottom of the NKK for better temperature control of the beer or beverage or other liquid inside the NKK.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view of a kettle/keg constructed according to a preferred embodiment of the invention.

FIG. 2 is an exploded perspective view of kettle/keg of FIG. 1.

FIG. 3 is a perspective view of a first embodiment of the compression displacement plate used within the kettle/keg of FIG. 1.

FIG. 4 is a side elevation, sectional view of the kettle/keg of FIG. 1 with the compression displacement plate of FIG. 4 in a beer storage position.

FIG. 5 is a side elevation, sectional view of the kettle/keg of FIG. 1 with the compression displacement plate of FIG. 4 in a beer dispensing position.

FIG. 6 is a perspective view of a second embodiment of the compression displacement plate used within the kettle/keg of FIG. 13.

FIG. 7 is a perspective view of a third embodiment of the compression displacement plate used within the kettle/keg of FIG. 1.

FIG. 8 is a perspective view of a fourth embodiment of the compression displacement plate used within the kettle/keg of FIG. 1.

FIG. 9 is a side elevation, sectional view of the kettle/keg of FIG. 1 with inserted hop and grain baskets with agitator assembly.

FIG. 10 is a side elevation, sectional view of the kettle/keg of FIG. 1 according to yet another embodiment of the invention.

FIG. 11 is a side elevation, sectional view of the kettle/keg of FIG. 5 with the addition of a sludge separator stand-off portion.

FIG. 12 is a side elevation, sectional view of kettle/keg of FIG. 1 with additional features incorporated into the assembly.

FIG. 13 is a side elevation, sectional view of an alternate aspect of the kettle/keg of FIG. 1 with the compression displacement plate of FIG. 6 in a beer dispensing position.

FIG. 14 is a side elevation, sectional view of the compression displacement plate within the kettle/keg chamber and incorporating an alternate embodiment of the invention.

### DETAILED DESCRIPTION

The Newton Kettle Keg is a device designed to allow small batches of beer to be brewed at home by consumers who may have little to no previous experience as a brewer. The unit is designed to be a modular system that allows the user to begin with the most basic components and overtime add layers of capability and capacity by purchasing and adding modules to expand the home brewers capability and experience. At its most basic form the Kettle Keg is exactly that—a kettle for brewing beer that quickly and easily transforms into a storage keg by the addition of a weighted compression displacement plate (CDP).

The function of the CDP is to provide a means of adding energy to the beer such that it provides a motive force that facilitates its displacement. Using the F=P/A equation we can define the amount of weight or force to be added to CDP to effect a compressive value equal to a given desired minimum pressure required to properly dispense the beer without the use of potentially dangerous pressurized Carbon Dioxide.

The weighted CDP fits into the inside diameter of the kettle keg and contains a fitted seal such that there is an air tight dynamic seal between the liquid and the atmosphere. The CDP is intended to also provide an air tight environment for the beer to ferment while simultaneously providing the mechanism for the beer to be stored and served without the addition of carbon dioxide or other motive gas.

The CDP may have a through hole in its center to allow a flow path for the beer to be displaced into any number of modules meant to facilitate the dispensing of the liquid. The CDP may have a through hole that is off center to allow for a crank mechanism to be fitted in the center of the CDP to provide a mechanical method for compression displacement. The CDP may not have a hole in it at all while the kettle keg itself may also be fitted with a port in its bottom or side to provide a flow path for the beer to exit the kettle keg. An important feature of the compression displacement plate is that it contains a small threaded valve in its top surface that allows the air to be bled from the air gap between the top surface of the beer and the bottom of the compression displacement plate while positioning the compression displacement plate for fermentation and storage.

In such an instance where the CDP has a center through hole it may also be fitted with a displacement tube. The function of the displacement tube is to provide a flow path for the beer from the bottom of the kettle keg while also adding to the axial stability by way of an additional structural element. The CDP may also have a threaded center hole and instead of the displacement tube, may be fitted with a fitting that connects to a coiled flexible tube of either a plastic or stainless material to provide the flow path.

In such an instance where the CDP may be fitted with a hand crank attached to a ball screw mechanism mounted in the center of the plate and if so mounted it may also have an off center through hole to facilitate either a displacement tube or threaded fitting.

Another feature of the kettle keg is the hop and grain baskets which allow the flow of heated water to permeate the baskets while containing the used hops and grains to prevent them from disbursing throughout the finished beer. These baskets may be affixed during the brewing process such that they are completely submerged in the brew water and may be agitated in an up and down motion to maximize the steeping flow transfer manually or automatically by using an additional bracketed agitator motor or hand crank. The baskets can then be completely removed once the wort is complete without any residue being left in the beer.

The kettle keg may also be fitted with an immersion cooler as well as an immersion heater should the operator choose to heat the unit using an additionally available modular conduction heating/cooling unit.

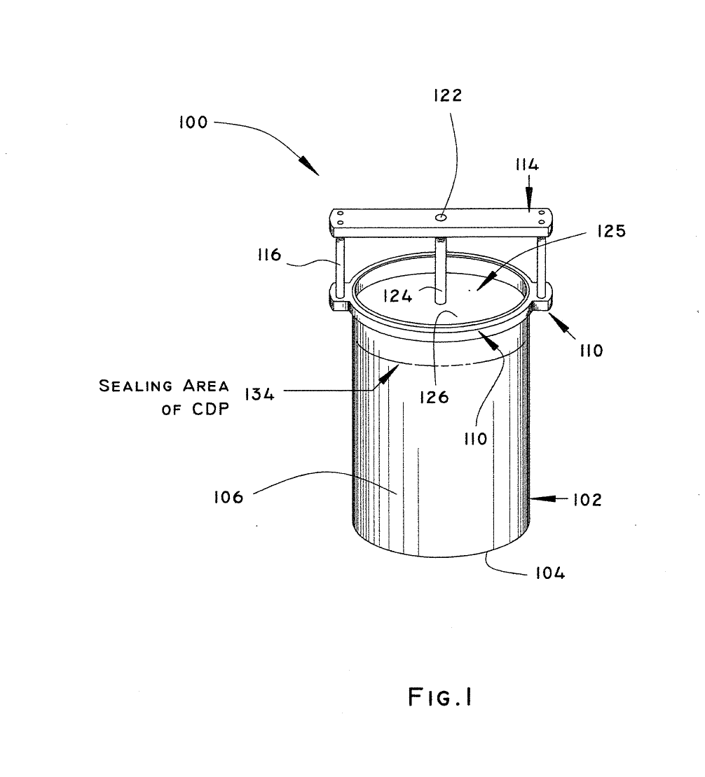

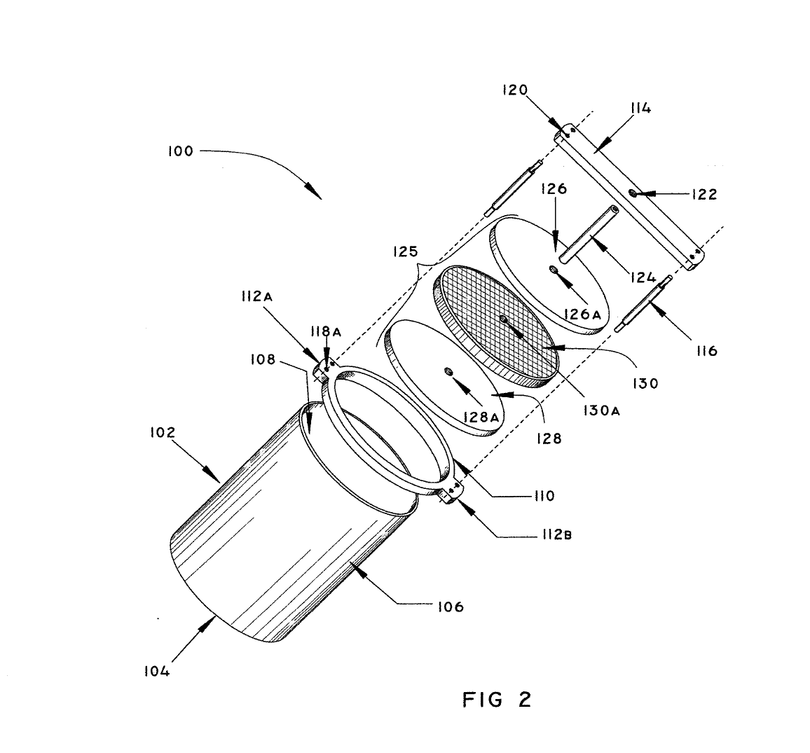

Attention will now be directed to the figures in which FIGS. 1 and 2 illustrate the kettle keg 100 as constructed according to a preferred embodiment of the invention. Kettle Keg 100 includes a container 102 having a bottom 104 and upright sidewalls 106 defining the chamber 108 used to house the beer, or fermentable or non-fermentable liquid, or beverage.

A lower concentricity/mounting bracket 110 is mounted to an upper surface and on the outside diameter of the container 102 flush with the top periphery of sidewall 106. Bracket 110 includes flanges 112a, 112b disposed on opposite sides of the bracket and extend outside of the container 102 diameter.

Lower concentricity bracket 110 interfaces with an upper concentricity/mounting bracket 114 that extends across and above the flanges 112a, 112b, where bracket 114 is coupled to bracket 110 via a plurality of connecting rods 116 that space the upper bracket 114 above the lower bracket 110. In an embodiment, the connecting rods 116 include a larger diameter central section and peripheral ends of smaller diameters that insert into respective apertures—such as aperture 118 in flange 112a, and aperture 120 in upper mounting bracket 114. Bracket 114 also includes a centrally located flow port aperture 122, which is maintained in static position by action of the assembled brackets 110, 114. Aperture 122 is in fluid communication with a displacement tube 124 that extends into the kettle keg chamber 108 and through which the liquid within the chamber is dispensed.

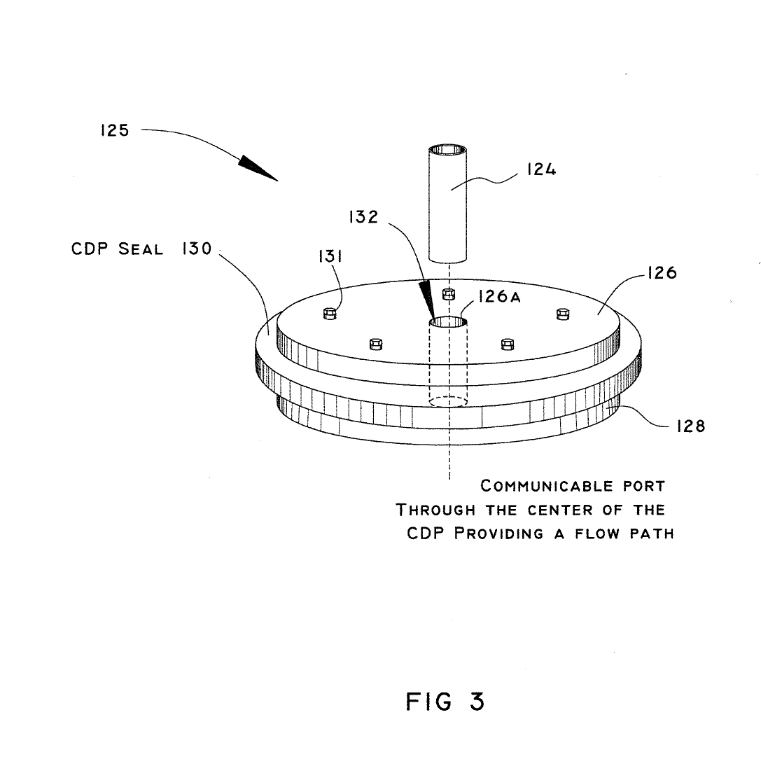

A key aspect of the design, and shown in FIGS. 2 and 3, is a compression displacement plate (CDP) assembly 125 formed of a rigid top plate 126 and bottom plate 128 that sandwiches a CDP seal 130 therebetween. Seal 130 is preferably made of a flexible material such as EPDM rubber. Plates 126, 128, and 130 are coupled together as via bolts 131 spaced about the expanse of the assembly 125.

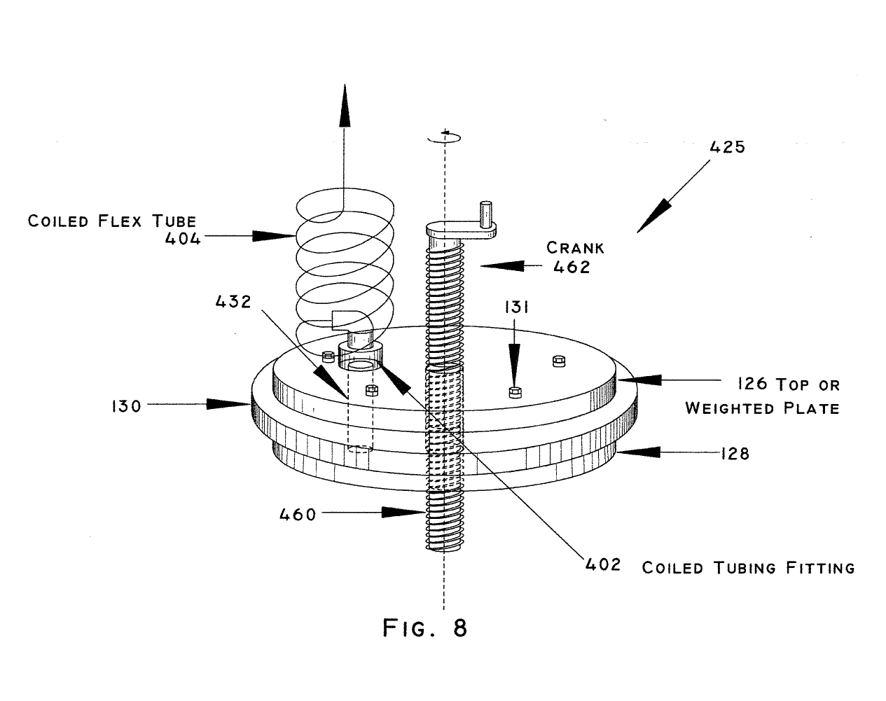

Each of the assembly parts 126, 128, and 130 include an axially aligned aperture 126a, 128a, and 130a, respectively, which collectively form through-aperture 132. Apertures 126a, 128a, and 130a are preferably centrally aligned with the aperture 122 on the upper mounting bracket 120 so that the displacement tube 124 may be commonly received therethrough and extend into the interior of chamber 108. Other aspects of the invention include through-aperture 132 in a non-central or off-axis location such as shown in FIG. 8. Brackets 110 and 114 act to maintain the level alignment of the CDP assembly 125 within the chamber 108 so that the seal 130 bears evenly against the interior of the upright sidewalls 106 and against the top surface of the liquid (e.g. at sealing level 134 as shown in FIG. 1) and prevents ambient air from leaking into the fermenting liquid.

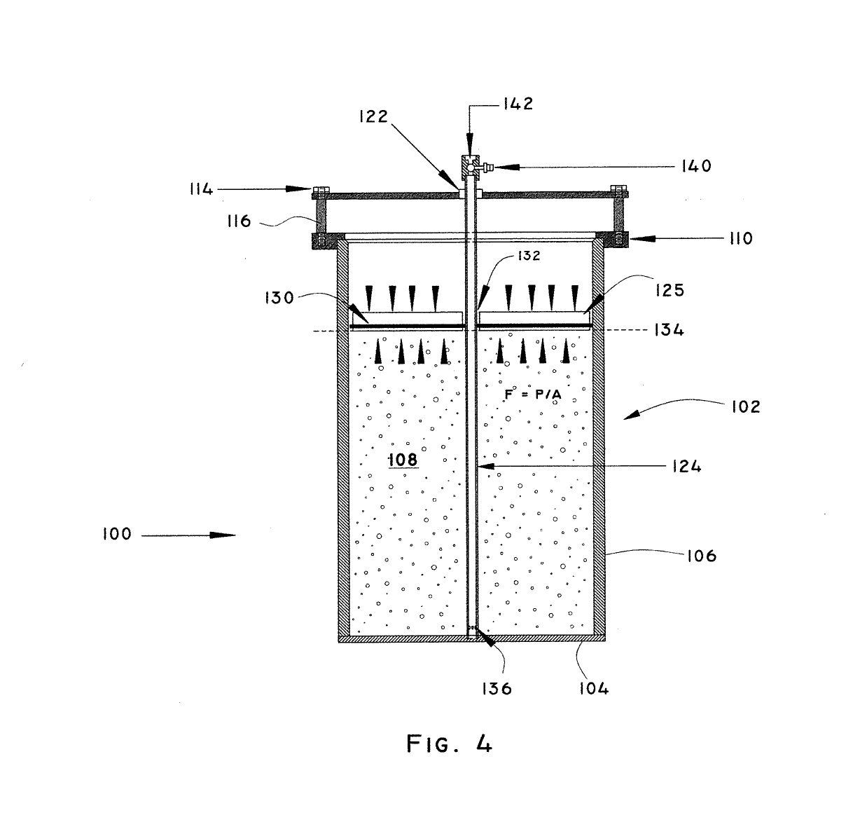

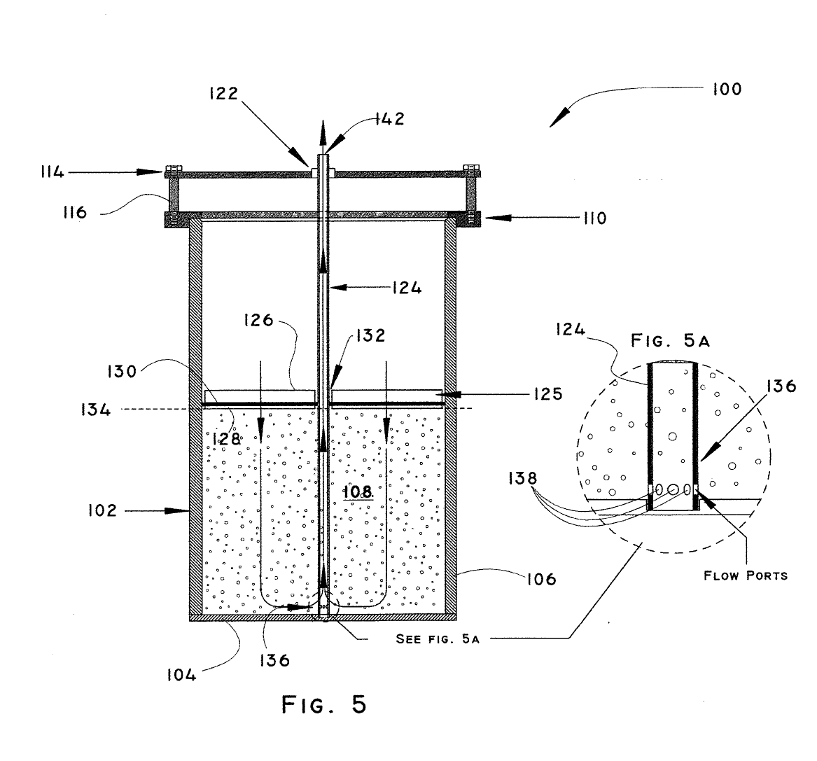

Another configuration of the compression displacement plate includes a channel formed about the peripheral edge of the plate and an O-ring within the channel to bear against the upright sidewalls of the container to create an air tight environment within the chamber. FIG. 4 is a side elevation, sectional view of the kettle/keg 100 of FIG. 1 with the compression displacement plate 125 of FIG. 4 in a beer storage position. Fluid displacement tube 124 extends through the aperture 122 of the upper concentricity bracket 114 and axially aligned through-aperture 132 of the compression displacement plate assembly 125 and into the chamber 108 of the kettle keg/container 102 so that a lower end 136 is adjacent a lower end of chamber 108. The lower end 136 of displacement tube 124 includes a plurality of perforations 138 (see FIG. 5) into the interior of the tube 124 so that liquid from within the chamber 108 may be withdrawn up and out a

U.S. PATENT APPLICATION PAGE 7 MJM Do. No. 3579-0002 top end of the tube. In a storage condition as shown in FIG. 4, however, a blocking valve 140 at the top of tube 124 is closed so that the fluid is not allowed to flow through an upper communicable flow port 142. In a dispensing condition as shown in FIG. 5, blocking valve 140 would be removed or placed in an open position. The flow port 142 is affixed in such a way such that when the CDP with flexible seal 130 is depressed within the container it creates an upward flow path resulting in a fluid flow that travels up the displacement tube 124 to the blocking valve 140, which may be in an open or closed position.

Fluid within the storage area 108 of container 102 is maintained at a level 134 dictated by the properties of the fluid and the compression plate assembly 125. A graphical representation of Force =Pressure/Area formula is shown wherein hydrodynamic equilibrium is established such that the weighted compression displacement plate 125 is applying a downward force on the fluid. Plate 125 is held in place on a top surface 134 of the fluid as a result of the equal yet opposite resistive force of the compressive value of the fluid, thus reaching a point of hydrodynamic equilibrium with the pressure inside the container 102 occurring as a result of the communicable port 142 being blocked by closing the dispensing valve 140. Flexible seal 130 around the compression displacement plate 125 creates an airtight seal preventing the outflow of fluids or the inflow of environmental gases.

FIG. 5 is a side elevation, sectional view of the kettle/keg 100 of FIG. 1 with the compression displacement plate 125 of FIG. 4 in a beer dispensing position. In one aspect of the invention, the weight of compression displacement plate 125 presses perpendicularly against the top surface 134 of the liquid within chamber 108 across its entire expanse. The seal 130 of CDP 125 against the inside surfaces of the container 102 prevents seepage of liquid upward and around the outer edges of CDP 125, as well as preventing air from above CDP 125 from seeping into the liquid within chamber 108. With the communication port 142 in an open position (as via the blocking valve 140 removed or opened), the liquid within chamber 108 can then be volumetrically displaced by forcing it into and up through fluid displacement tube 124. FIG. 5A illustrates how the liquid moves from the chamber 108 and through the perforations 138 in the lower part 136 of tube 124. With the CDP 125 providing pressure against the top surface 134 of the liquid within the chamber, this causes the liquid to move along the path of least resistance which in this case is up through the tube where the liquid can be dispensed.

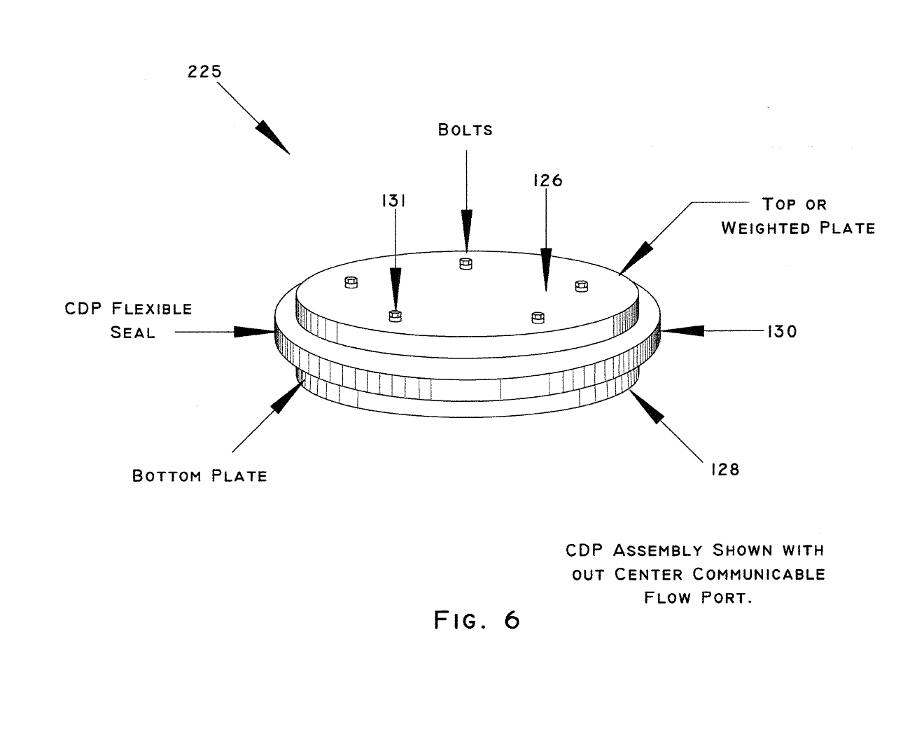

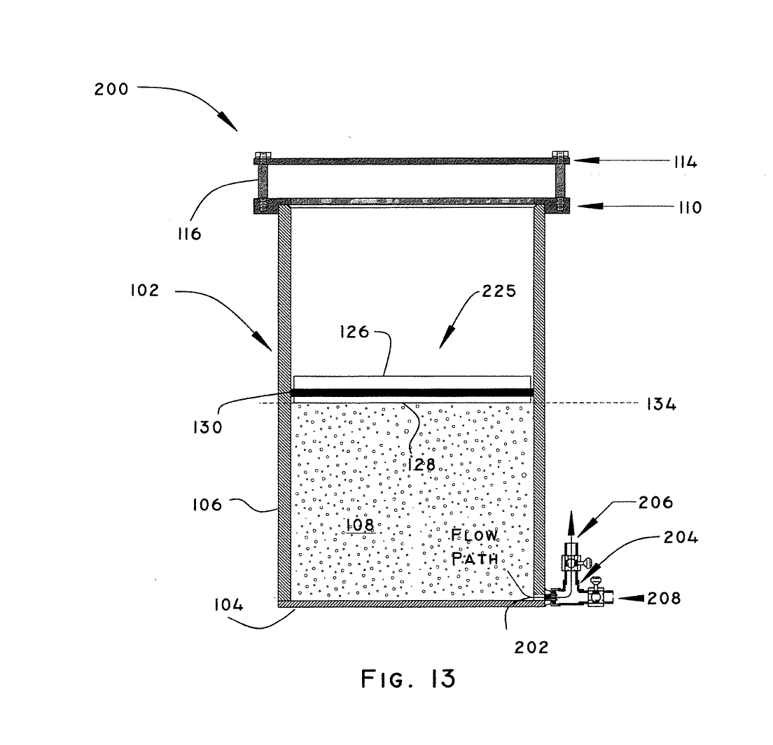

FIG. 6 illustrates an alternate embodiment of a CDP 225 for use with a kettle/keg embodiment 200 such as shown in FIG. 13. As with the compression displacement plate assembly 125 of FIG. 3, CDP assembly 225 is formed of a rigid top plate 126 and bottom plate 128 that sandwiches a CDP seal 130 therebetween and are coupled together as via bolts 131 spaced about the expanse of the assembly 125. Unlike CDP 125, however, the alternative version 225 shown in FIG. 6 is not constructed to receive a displacement tube 124 therethrough and thus does not need axially aligned through holes 126a, 128a, and 130a forming through-aperture 132. Instead, and as shown in FIG. 13, CDP assembly 225 rests against the top surface 134 of the liquid within chamber 108. Instead of the liquid being dispensed in an upper position such as shown in FIG. 5, the liquid instead is dispensed out a side port 202 formed through a lower portion of sidewall 106. Dispensing valve 204 in fluid communication with the lower port 202 includes two valves operating a fluid displacement part 206 and a sludge clean-out part 208, respectively. The fluid displacement part 206 can then be coupled to a dispensing tube (not shown) with a dispensing port above the fluid level 134 because the CDP provides pressure against the surface of the fluid to provide such motive force. Such motive force also acts to provide additional pressure beyond the gravity of the fluid itself to assist with cleaning out the chamber 108 of sludge that may form over time.

Each of the assembly parts 126, 128, and 130 include an axially aligned aperture 126a, 128a, and 130a, respectively, which collectively form through-aperture 132. Apertures 126a, 128a, and 130a are preferably centrally aligned with the aperture 122 on the upper mounting bracket 120 so that the displacement tube 124 may be commonly received therethrough and extend into the interior of chamber 108. Other aspects of the invention include through-aperture 132 in a non-central or off-axis location such as shown in FIG. 8. Brackets 110 and 114 act to maintain the level alignment of the CDP assembly 125 within the chamber 108 so that the seal 130 bears evenly against the interior of the upright sidewalls 106 and against the top surface of the liquid (e.g. at sealing level 134 as shown in FIG. 1) and prevents ambient air from leaking into the fermenting liquid.

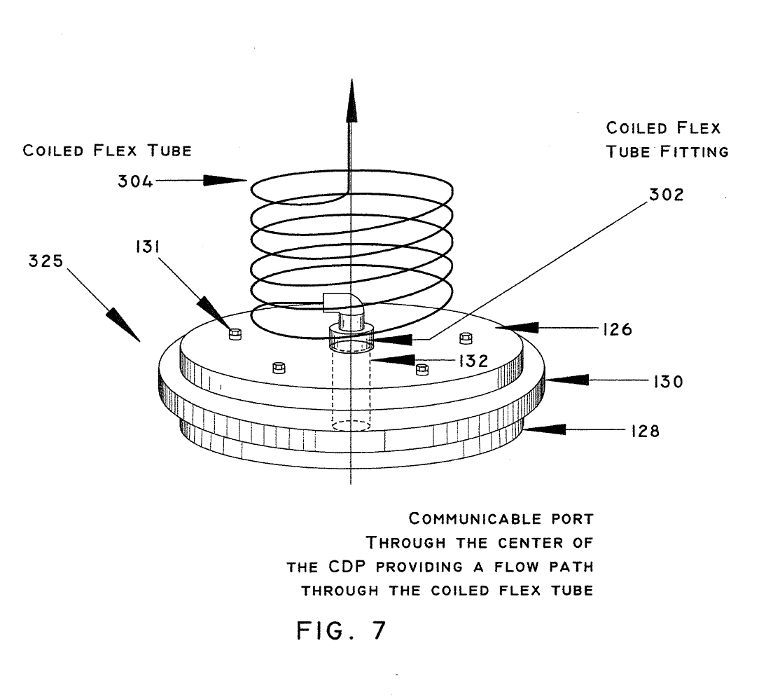

FIG. 7 is a perspective view of a third embodiment of the compression displacement plate 325 used within the kettle/keg of FIG. 1. Compression displacement plate (CDP) assembly 325 is formed of a rigid top plate 126 and bottom plate 128 that sandwiches a CDP seal 130 therebetween. Plates 126, 128, and 130 are coupled together as via bolts 131 spaced about the expanse of the assembly 125.

Each of the assembly parts 126, 128, and 130 include an axially aligned aperture 126a, 128a, and 130a, respectively, which collectively form through-aperture 132. A flex-tube fitting 302 is coupled to a top of through-aperture 132. A coiled flex tube 304 is then coupled to the end of fitting 302 and may include a valve or dispensing portion (not shown) on the end thereof. Pressure of the CDP assembly 325 against the top surface of the liquid provides motive force of the liquid up through aperture 132, fitting 302, and flex tube 304 where it can be dispensed at a terminal end thereof. The seal 130 of CDP assembly 325 bears evenly against the interior of the upright sidewalls 106 and against the top surface of the liquid (e.g. at sealing level 134 as shown in FIG. 1) and prevents ambient air from leaking into the fermenting liquid.

FIG. 8 is a perspective view of a fourth embodiment of the compression displacement plate 425 used within the kettle/keg of FIG. 1. Compression displacement plate (CDP) assembly 425 is formed of a rigid top plate 126 and bottom plate 128 that sandwiches a CDP seal 130 therebetween. Plates 126, 128, and 130 are coupled together as via bolts 131 spaced about the expanse of the assembly 125.

Each of the assembly parts 126, 128, and 130 include an axially aligned aperture 126a, 128a, and 130a, respectively, which collectively form through-aperture 432. Unlike the embodiment shown in FIG. 7, through-aperture 432 is formed off-axis with respect to the axis of CDP 425. A flex-tube fitting 402 is coupled to a top of through-aperture 432. A coiled flex tube 404 is then coupled to the end of fitting 302 and may include a valve or dispensing portion (not shown) on the end thereof.

A second aperture 460 is formed through a center axis of the CDP assembly 425 and passes through each of the parts 126, 128, and 130. The centered aperture 460 is threaded to receive a threaded crank 462 therethrough. Turning the crank 462 drives the CDP assembly 425 downward against the top surface of the liquid within chamber 108 and provides additional and controllable motive force via volumetric displacement against the liquid to propel it out a dispensing port (not shown). That is, pressure of the CDP assembly 425 against the top surface of the liquid provides motive force of the liquid up through aperture 132, fitting 402, and flex tube 404 where it can be dispensed at a terminal end thereof. As with the other embodiments of the CDP assemblies 125, 225, and 325, the seal 130 of CDP assembly 425 bears evenly against the interior of the upright sidewalls 106 and against the top surface of the liquid (e.g. at sealing level 134 as shown in FIG. 1) and prevents ambient air from leaking into the fermenting liquid.

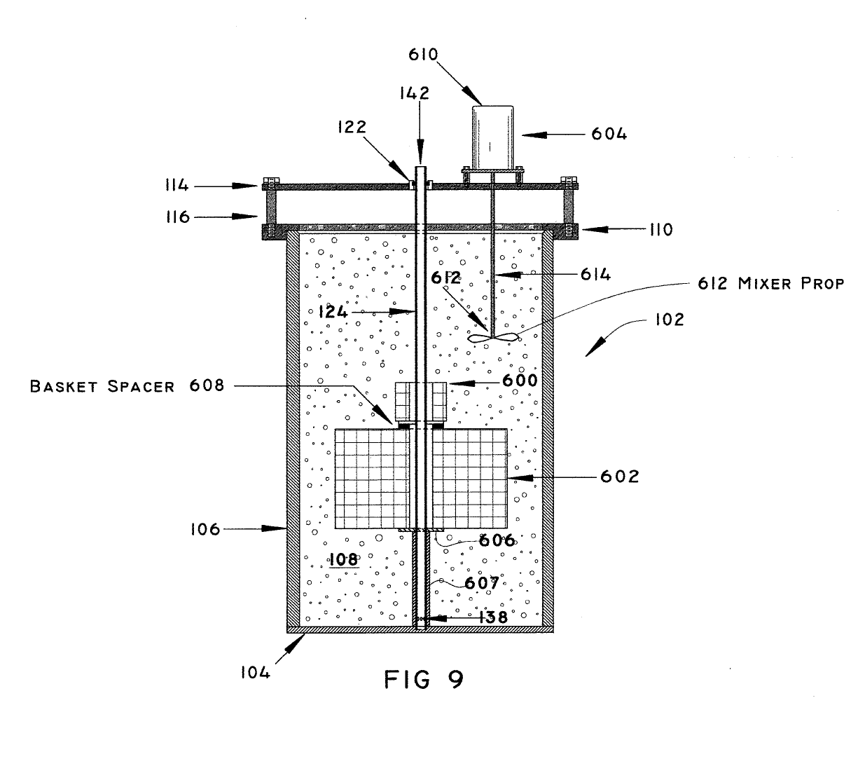

FIG. 9 is an illustration of the kettle/keg 100 of FIG. 1 with inserted hop and grain baskets 600, 602 with agitator assembly 604. All like elements are the same as in previous embodiments. In addition to serving as a dispensing path for the liquid within chamber 108, displacement tube 124 is further used to retain and hold in position the grain and hop baskets 602, 600 during the cooking process. The grain basket 602 is a perforated container having a bottom and upright sidewalls which are permeable to fluids as well as the oils in order to provide for proper blending during the cooking process. As with the grain basket, the hop basket 600 is a perforated container having a bottom and upright sidewalls which are permeable to fluids as well as the oils in order to provide for proper blending during the cooking process. A basket support washer 606 positioned atop a basket standoff section 607, which itself is positioned around a lower portion of the displacement tube 124. Washer 606, in combination with standoff section 607, is used to prevent the grain and hop baskets 602, 600 from descending past a specified vertical position within the container, e.g. that they are suspended in the middle of the liquid mixture. A basket spacer 608 is used to create a space between the hop and grain baskets 600, 602 whereby an even flow distribution is achieved in both the grain basket and the hop basket. Agitator assembly 604 includes an agitator motor 610 coupled to a mixer prop 612 that extends into the liquid of chamber 108 via a rotational axel 614. The mixer prop 612 is used to create a turbulent flow condition within the chamber 108 whereby a steady and continuous mixing is generated within the container 102.

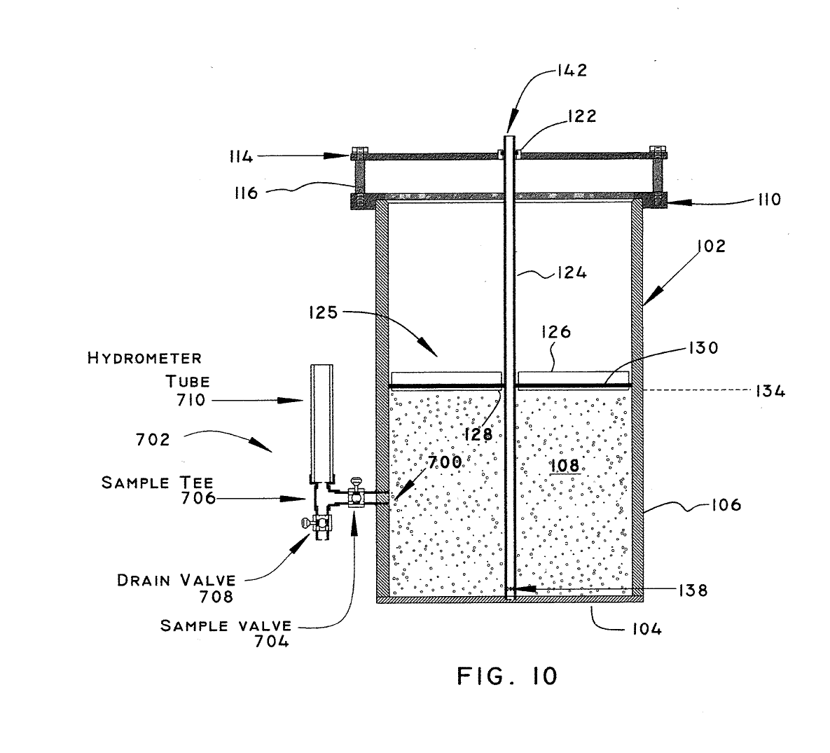

FIG. 10 illustrates the kettle/keg 100 of FIG. 1 but with a side port 700 into which an assembly 702 of several accessories are coupled. Port 700 is formed through a sidewall 106 of the container 102 and below the fluid level 134 of the container during normal use. Assembly 702 includes a sample valve 704 for admitting fluid therethrough, a sample tee 706 that distributes the fluid to both the lower drain valve 708 and the hydrometer tube 710. Without the CDP 125, the top of hydrometer tube 710 can only be positioned below the fluid level 134. The CDP, however, provides additional motive pressure against the fluid being measured so that the fluid rises fully within the tube no matter the height of the tube 710.

When filled with a fermentable beverage or fluid, the depression of the DCP flexible seal 130 within the container 102 creates a flow path toward the sample valve 704. When valve 704 is opened, the beer or fermentable beverage flows through the sample tee 706 into the hydrometer tube 710 so that a measurement of the specific gravity of the internal fluid can be taken. Once the measurement has been taken, drain valve 708 may be opened to allow the fermentable fluid to escape the integral hydrometer.

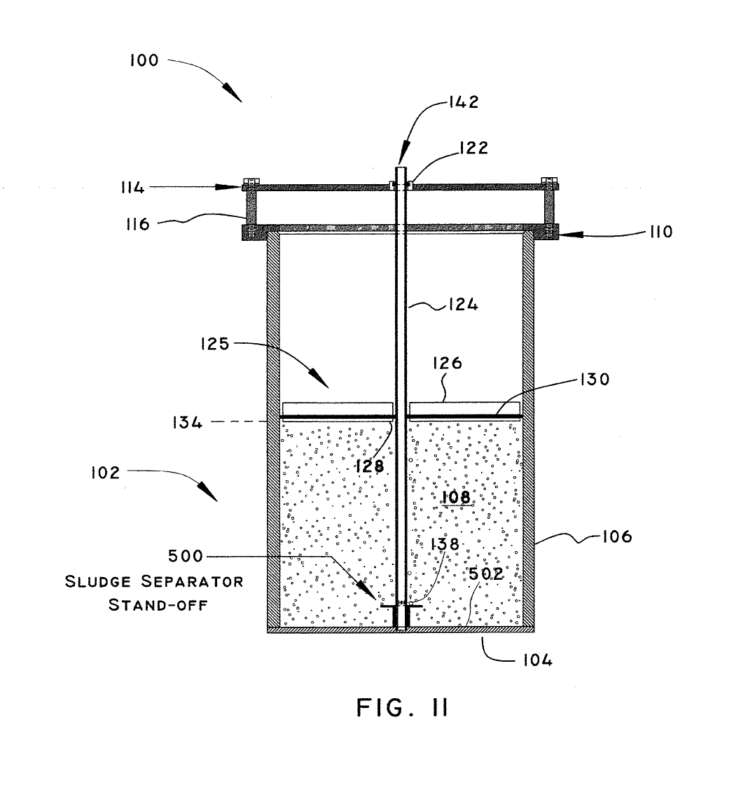

FIG. 11 illustrates the kettle/keg 100 of FIG. 1 with the compression displacement plate 125 of FIG. 4 in a beer dispensing position. The embodiment shown in FIG. 9 is essentially identical to the one shown in FIG. 5, except for the inclusion of a stand-off sludge separator 500 that suspends the perforated section 138 of the riser tube 124 from a bottom 502 of the chamber 108 so that sludge, which typically settles to the bottom 502 of container 102 during the fermentation process, does not block the perforation holes 138. Separator 500 is a frame into which the riser tube slides and is sized to suspend the perforations a designated distance depending upon the expected thickness of the sludge layer. As with the embodiment shown in FIG. 5, the weight of compression displacement plate 125 presses perpendicularly against the top surface 134 of the liquid within chamber 108 across its entire expanse. The seal 130 of CDP 125 against the inside surfaces of the container 102 prevents seepage of liquid upward and around the outer edges of CDP 125, as well as preventing air from above CDP 125 from seeping into the liquid within chamber 108. With the communication port 142 in an open position (as via the blocking valve 140 removed or opened), the liquid within chamber 108 can then be volumetrically displaced by forcing it into and up through fluid displacement tube 124. FIG. 5A illustrates how the liquid moves from the chamber 108 and through the perforations 138 in the lower part 136 of tube 124. With the CDP 125 providing pressure against the top surface 134 of the liquid within the chamber, this causes the liquid to move in the past of least resistance which in this case is up through the tube where the liquid can be dispensed.

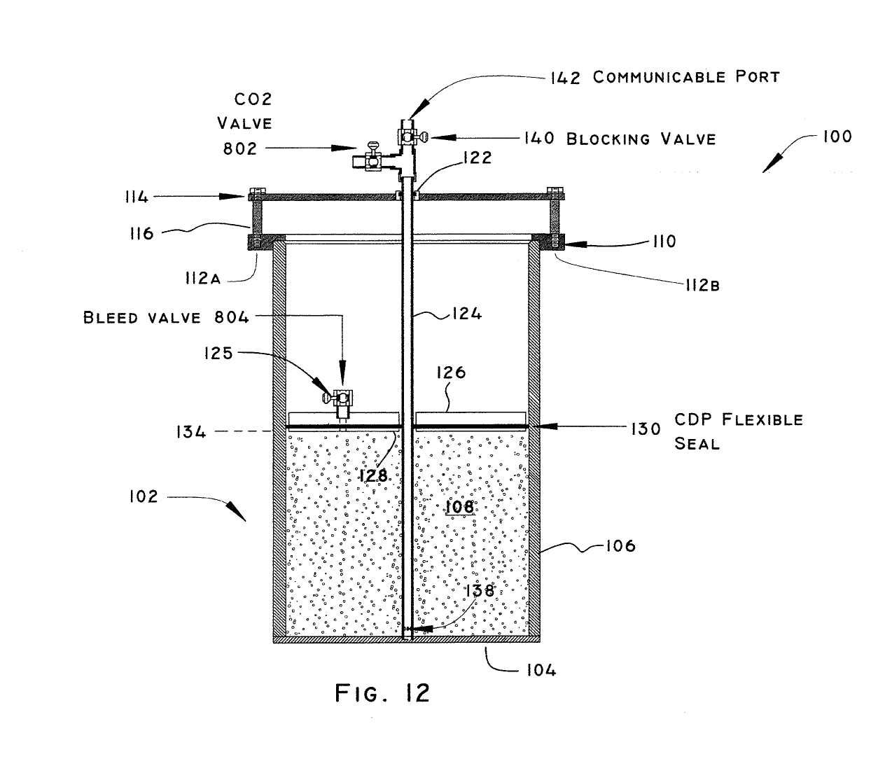

FIG. 12 illustrates the kettle keg assembly 100 fitted with an integral gas inlet valve 802. When blocking valve 140 is closed, CO2 can be injected through valve 802 to then pressurize the inside of the container 102. Pressurization can be relieved via bleed valve 804.

FIG. 13 is a side elevation, sectional view of an alternate aspect of the kettle/keg of FIG. 1 with the compression displacement plate 225 of FIG. 6 (e.g. without a centrally-located through aperture) in a beer dispensing position. CDP assembly 225 rests against the top surface 134 of the liquid within chamber 108. Instead of the liquid being dispensed in an upper position such as shown in FIG. 5, the liquid instead is dispensed out a side port 202 formed through a lower portion of sidewall 106. Dispensing valve 204 in fluid communication with the lower port 202 includes two valves operating a fluid displacement part 206 and a sludge clean-out part 208, respectively. The fluid displacement part 206 can then be coupled to a dispensing tube (not shown) with a dispensing port above the fluid level 134 because the CDP provides pressure against the surface of the fluid to provide such motive force. Such motive force also acts to provide additional pressure beyond the gravity of the fluid itself to assist with cleaning out the chamber 108 of sludge that may form over time.

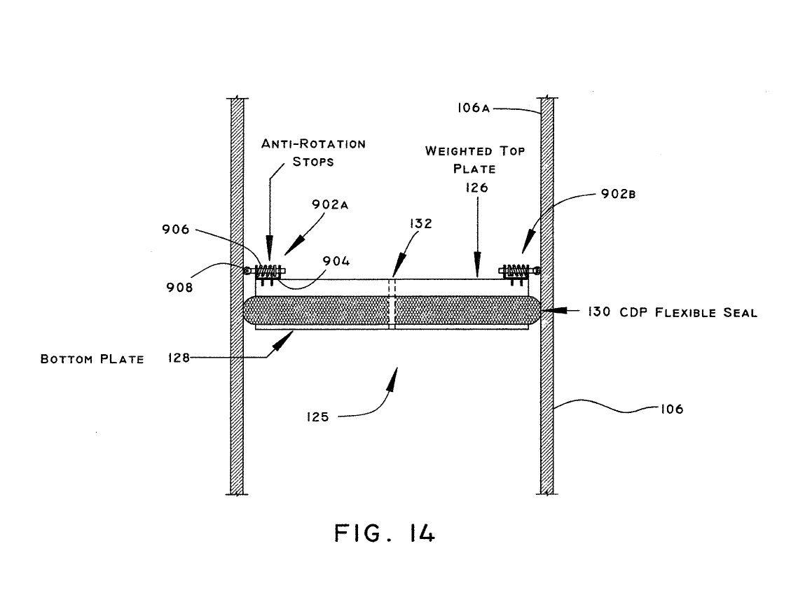

FIG. 14 is a side elevation, sectional view of the compression displacement plate within the kettle/keg chamber and incorporating an alternate feature of the invention. The CDP 125 includes a set of anti-rotation stops mounted to a top surface of the weighted top plate 126 of CDP 125, e.g. left and right stop assemblies 902a, 902b affixed at 90 degree intervals about the periphery of plate 126 (front and back assemblies are not shown). Each stop assembly includes a clip C-frame 904 mounted to plate 126, a spring 906 mounted within the frame, and a rod mounted to the spring and having a roller 908 provided on an outer end of the rod. Roller 908 is outwardly biased by spring 906 against the inside surface 106a of the upright wall 106 of container 102 so as to exert a force against the wall and keep concentricity of the flexible seal 130 so that an air- and fluid-tight seal is maintained.

Other alternate aspects of the invention include additional features. In one feature, an integral heating and/or cooling element allows the kettle keg to serve as the kettle in which the beer or other beverage or liquid is cooked, boiled or otherwise heated as part of the preparation of said beer, beverage or liquid. In another feature, the weight of the CDP against the top surface of the liquid to provide a motive pressure force is supplemented by spring loading the CDP downward. Yet another feature may include a compression displacement plate with a connection coil attached internally allowing for bi-directional flow allowing the beer or beverage or other liquid to flow through the coil out of the kettle keg as the displacement plate is lowered. This arrangement would also allow beer to flow through the coil into the kettle keg, thus allowing for a beer to be mixed with a beer, or a beer to be mixed with a beverage, or a beer to be mixed with another liquid, or a liquid to be mixed with another liquid, or a liquid to be mixed with a beverage, or a beverage to be mixed with a beverage, or to allow water of varying temperature to enter and exit out of an outtake valve at the bottom of the kettle keg for better temperature control of the beer or beverage or other liquid inside the kettle keg.

Having described and illustrated the principles of the invention in a preferred embodiment thereof, it should be apparent that the invention can be modified in arrangement and detail without departing from such principles. I claim all modifications and variation coming within the spirit and scope of the following claims.

What is claimed is:

1. A kettle keg for brewing and dispensing beer, comprising:
a container having a bottom and upright sidewalls defining a chamber configured to receive a fermenting liquid;
a dispensing port in fluid communication with the chamber;
a compression displacement plate slidably received within the container and between the upright sidewalls and configured to rest on a top surface of liquid received in the container to define an adjustable volume of the chamber; and
means for forcing the compression displacement plate against the top surface of the liquid to create a motive force of the liquid toward the dispensing port.

2. The kettle keg of claim 1, wherein the compression displacement plate includes peripheral edges forming an air seal with the upright sidewalls.

3. The kettle keg of claim 2, wherein the compression displacement plate includes a top weighted plate and a bottom plate sandwiching a flexible seal layer therebetween, with an outer periphery of the flexible seal layer having a larger diameter than the top and bottom plates so as to bear against inside surfaces of the upright sidewalls.

4. The kettle keg of claim 2, wherein the compression displacement plate includes a channel formed about the peripheral edge of the plate and an O-ring within the channel to bear against the upright sidewalls of the container to create an air tight environment within the chamber.

5. The kettle keg of claim 1, wherein the means for forcing is a weight of the compression displacement plate against the top surface of the liquid.

6. The kettle keg of claim 1, wherein the means for forcing includes a threaded crank passing through the compression displacement plate.

7. The kettle keg of claim 1, further including:
an aperture formed through the compression displacement plate and opening into the chamber; and
a dispensing tube received within the aperture and extending down into the chamber.

8. The kettle keg of claim 7, wherein the aperture is formed through a center of the compression displacement plate.

9. The kettle keg of claim 7, wherein the aperture is formed through an off-center of the compression displacement plate.

10. The kettle keg of claim 7, wherein the dispensing tube includes a plurality of perforations into an interior of the tube so that liquid from within the chamber may be withdrawn up and out a top end of the tube.

11. The kettle keg of claim 10, wherein the perforations are formed in a lower end of the tube adjacent a bottom of the chamber.

12. A method for dispensing beer, comprising the steps of:
fermenting beer within a chamber bounded by a bottom, upright sidewalls, and a compression displacement plate moveable between the upright sidewalls to create an adjustable volume within the chamber;
forcing the compression displacement plate against a top surface of the fermenting beer to create a force on the beer toward a dispensing port;
allowing the compression displacement plate to move vertically along the upright sidewalls while contacting the top surface of the fermenting beer to accommodate a change in volume of the fermenting beer until the beer is substantially fermented and ready for drinking; and
opening a dispensing port and allowing the substantially fermented beer to flow therethrough under continuing force of the compression displacement plate whereby the compression displacement plate is allowed to slide downward as the beer is dispensed.

13. The method of claim 12, wherein the step of forcing the compression displacement plate against a top surface of the fermenting beer includes maintaining the compression displacement plate in a level alignment with respect to the top surface of the fermenting beer and perpendicular to the upright sidewalls of the chamber.

14. The method of claim 12, further including the step of pressurizing the chamber with a gas.
